(19) United States
(12) Patent Application Publication
(10) Pub. No.: US 2008/0122756 A1
(43) Pub. Date: May 29, 2008

(54) DISPLAY APPARATUS AND DRIVE METHOD THEREOF

(75) Inventors: Somei Kawasaki, Saitama-shi (JP); Masami Iseki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/771,120

(22) Filed: Jun. 29, 2007

(30) Foreign Application Priority Data
Jun. 30, 2006 (JP) 2006-181669

(51) Int. Cl. G09G 3/30

(52) U.S. Cl. 345/76; 348/333.01

(57) ABSTRACT

A pixel circuit of a display apparatus includes a transistor M5 having a drain connected to a light-emitting element, a switch S1 connected between a power supply and a source of the transistor M5, switches S2 and S3 connected between wiring to which a data current is supplied and the source of the transistor M5, capacities C1 and C2 of which one-side terminals are connected between the switches S2 and S3, and a switch S4 provided between the gate of the transistor M5 and a reference voltage supply. The pixel circuit performs a first operation of inputting the data current into the source of the transistor M5 by turning on the switches S2 and S3 and turning off the switch S1 while turning on the switch S4 to set the gate of the transistor M5 to the reference potential, a second operation of connecting the power supply to the connection point of the capacities C1 and C2 while the switches S4 and S3 are turned off, and a third operation of turning on the switch S1 when a light-emitting element is made to emit light.

### BACKGROUND OF THE INVENTION

1. Field of the Invention

The present invention relates to a display apparatus and a drive method thereof, and more particularly to an active matrix type display apparatus provided with pixel circuits for supplying currents to light-emitting elements arranged in two dimensions and a drive method of the display apparatus.

2. Description of the Related Art

An electroluminescent (EL) element is a light-emitting element that emits light by a current injection, and a current setting system was proposed in U.S. Pat. No. 6,373,454 as one of the light emission control system of the EL element.

FIG. 7 illustrates a configuration example of a pixel circuit of the current setting system including an EL element, which configuration is disclosed in the U.S. patent as mentioned above.

Scanning signals P11 and P12 are prepared, and a data current Idata as an information signal is input into an information line. The anode of the EL element is connected to the drain terminal of a thin film transistor (TFT) M9, and the cathode of the EL element is connected to the ground potential GND. The source of the transistor M9 is connected to the drain of a transistor M8, the drain of a transistor M6, and the source of a transistor M7. The drain of the transistor M7 is connected to the information line, and the source of the transistor M6 is connected to the gate of the transistor M8 and one terminal of a capacity C. The other terminal of the capacity C and the source of the transistor M8 are connected to a power supply Vcc. The scanning signal P11 is input into the transistors M7 and M9, and the scanning signal P12 is input into the transistor M6.

The transistors M8 and M9 are P type thin film transistors (PMOS transistors), and the transistors M6 and M7 are N type thin film transistors (NMOS transistors).

In the following, the operation of the pixel circuit will be described with reference to FIGS. 8, 9, and 10. FIG. 8 is a timing chart illustrating the operation of the pixel circuit, and FIGS. 9 and 10 are diagrams for describing the operation of the pixel circuit. In FIGS. 9 and 10, a mark o indicates a transistor in the ON state thereof, and a mark x indicates a transistor in the OFF state thereof. In FIG. 8, a period of from a time t1 to a time t3 is the one for writing a data current, and a certain fixed period after the time t3 is a lighting period.

When the data current Idata is input, in the period of from the time t1 to the time t2 in FIG. 8, as the scanning signal P11, a HIGH level signal is input into the gates of the transistors M7 and M9, and as the scanning signal P12, a HIGH level signal is input into the gate of the transistor M6. Then, as illustrated in FIG. 9, the transistors M6 and M7 become their ON states, and the transistor M9 becomes the OFF state thereof. At this time, because the transistor M9 is not in the conduction state thereof, no currents flow through the EL element. A voltage according to the current drive ability of the transistor M8 is generated in the capacity C disposed between the gate terminal of the transistor M8 and the power supply Vcc by the data current Idata. In this way, the current to be applied to the EL element during a light emission period thereof is held as the gate voltage of the transistor M8.

At the time of supplying a current to the EL element, the scanning signal P12 is changed to the LOW level at the time t2 of FIG. 8, and thereby the transistor M6 is turned to the OFF state thereof as illustrated in FIG. 10. Then, at the time t3, the scanning signal P11 is changed to the signal of the LOW level. At this time, the transistor M9 is in the ON state thereof, and the transistors M6 and M7 are in their OFF states. Because the transistor M9 is in the conduction state thereof, a current according to the current drive ability of the transistor M8 is supplied to the EL element by the voltage generated in the capacity C, and the EL element emits light at the luminance (or brightness) according to the supplied current.

In FIG. 9, the transistor M8, which is a drive transistor, is separated from the EL element at the time of current writing and the transistor M6 becomes the ON state thereof, so that the diode configuration of the transistor M8 is formed. On the other hand, at the time of lighting, the transistor M6 is in the OFF state thereof, and the transistor M9 is in the ON state thereof, so that a current flows through the EL element.

Consequently, because the operation state of the transistor M8 at the time of lighting differs from that at the time of current writing, a writing current (or the data current Idata) is not the EL element drive current. In particular, at the time of performing a high luminance display, the phenomenon becomes remarkable. In order to settle the problem, the voltage of the power supply Vcc must be heightened.

However, the heightening of the voltage of the power supply Vcc makes the power consumption large, and it has been a problem of an EL display panel.

### SUMMARY OF THE INVENTION

The present invention settling the problem is first a display apparatus comprising light-emitting elements arranged in an array and pixel circuits for supplying currents to the light-emitting elements individually, each of the pixel circuits including: a drive transistor having a main electrode connected to a first power supply via the corresponding light-emitting element, another main electrode connected to a second power supply via a first switch and connected to an information line, to which a data current is supplied, via a series connection of a second and a third switches and a control electrode connected to a third power supply via a fourth switch; a first capacity having a terminal connected between the second and the third switches and another terminal connected to the second power supply; a second capacity having a terminal connected between the second and the third switches and another terminal connected to the control electrode of the drive transistor; and a unit which generates control signals for performing: a first operation of connecting the control electrode of the drive transistor to the third power supply by turning on the fourth switch and inputting the data current into the other main electrode of the drive transistor by turning off the first switch and turning on the second and the third switches; a second operation following the first operation of connecting the information line to the second power supply while turning off the third and the fourth switches; and a third operation following the second operation of supplying the current to the light-emitting elements by turning on the first switch and turning off the second switch.

The present invention is also a drive method of a display apparatus comprising light-emitting elements arranged in an array and pixel circuits for supplying currents to the light-emitting elements individually, each of the pixel circuit including: a drive transistor having a main electrode connected to a first power supply via the corresponding light-emitting element, another main electrode connected to a second power supply via a first switch and connected to an information line, to which a data current is supplied, via a series connection of a second and a third switches, and a control electrode connected to a third power supply via a fourth switch; a first capacity having a terminal connected between the second and the third switches, and another terminal connected to the second power supply; and a second capacity having a terminal connected between the second and the third switches, and another terminal connected to the control electrode of the drive transistor, the method comprising the steps of: connecting the control electrode of the drive transistor to the third power supply by turning on the fourth switch and inputting the data current into the other main electrode of the drive transistor by turning on the second and the third switches and turning off the first switch; connecting the information line to the second power supply while turning off the third and the fourth switches; and supplying the current to the light-emitting elements by turning on the first switch and turning off the second switch.

According to the present invention, because the drain-to-source voltage of the drive transistor can take almost the same voltage at both the time of large current writing and the time of display (lighting) operation, the power supply voltage can be decreased, the power consumption can be decreased.

The present invention is applied to a display apparatus such as an EL display apparatus including pixel circuits for supplying currents respectively and correspondingly to light-emitting elements arranged in two dimensions. Moreover, the present invention is applied to a portable or mobile telephone, a portable computer, a still camera, a video camera, or the like that uses the display apparatus like this, and an information processing apparatus that realizes a plurality of functions of the equipment as mentioned above.

Further features of the present invention will become apparent from the following description of exemplary embodiments with reference to the attached drawings.

### BRIEF DESCRIPTION OF THE DRAWINGS

FIG. 1 is a circuit diagram illustrating a pixel circuit of an EL display apparatus of the present exemplary embodiment.

FIG. 2 is a circuit diagram illustrating a concrete pixel circuit of the EL display apparatus of the present exemplary embodiment.

FIG. 3 is a diagram for describing the operation of the pixel circuit of the present exemplary embodiment.

FIG. 4 is a diagram for describing the operation of the pixel circuit of the present exemplary embodiment.

FIG. 5 is a diagram for describing the operation of the pixel circuit of the present exemplary embodiment.

FIG. 6 is a timing chart illustrating the pixel circuit.

FIG. 7 is a diagram illustrating a configuration example of a pixel circuit of a conventional current setting system including an EL element.

FIG. 8 is a timing chart illustrating the operation of the pixel circuit of the conventional display apparatus.

FIG. 9 is a diagram for describing the operation of the pixel circuit of the conventional display apparatus.

FIG. 10 is a diagram for describing the operation of the pixel circuit of the conventional display apparatus.

FIG. 11 is a diagram illustrating the circuit configuration of an EL display apparatus including pixel circuits arranged in two dimensions.

FIG. 12 is a diagram illustrating switching units of data currents Idata and the voltage of a power supply Vcc in the circuit configuration of FIG. 11.

FIG. 13 is a block diagram of an example of a digital still camera.

### DESCRIPTION OF THE EMBODIMENTS

In the following, exemplary embodiments of the present invention will be described in detail with reference to the attached drawings.

### First Exemplary Embodiment

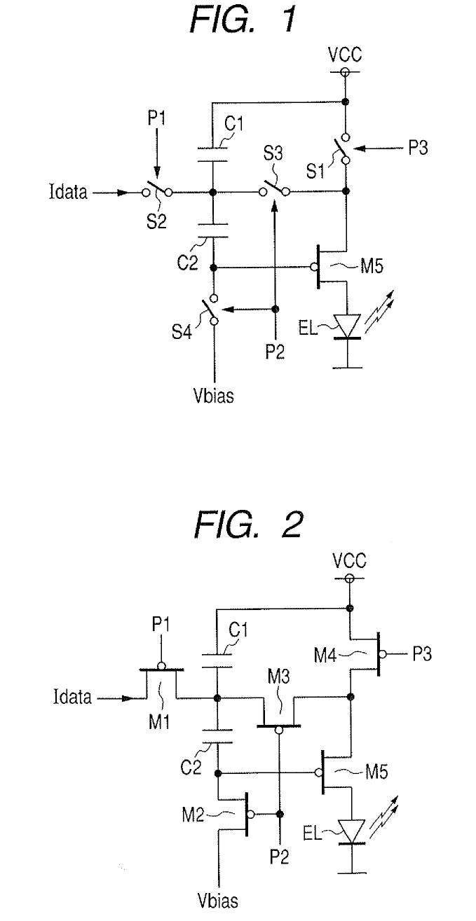

FIG. 1 is a circuit diagram illustrating a pixel circuit of an EL display apparatus of an exemplary embodiment of the present invention. In FIG. 1, switches S1, S2, S3, and S4 correspond to a first, a second, a third and a fourth switches, respectively.

The pixel circuit of the EL display apparatus of the exemplary embodiment illustrated in FIG. 1 is a circuit using a ground potential GND as a first power supply and a power supply Vcc as a second power supply.

A drive transistor M5 for driving a light-emitting element is configured in the manner in which one main electrode (drain) is connected to the light-emitting element and the other main electrode (source) is connected to the power supply Vcc, which is the second power supply, with the first switch S1 inserted between them.

From an information line Idata a data current (denoted by the same mark Idata unless they are confused) is supplied to the pixel circuit. The second and third switches S2 and S3, which are connected in series, are provided between the information line Idata and the drive transistor M5. A first capacity C1 is connected between the connection point of the second switch S2 and the third switch S3 and the power supply Vcc, and a second capacity C2 is connected between the connection point of the second switch S2 and the third switch S3 and the control electrode (gate) of the drive transistor M5.

Furthermore, the fourth switch S4 is provided between the gate of the drive transistor M5 and a reference voltage source Vbias, which is a third power supply. The reference voltage source Vbias is held to have a constant reference potential (Vbias).

The cathode side of the EL element is connect to the ground potential GND, which is the first power supply.

The on/off control of the second switch S2 is performed by a control signal (scanning signal) P1; the on/off control of the fourth switch S4 and the third switch S3 is performed by a control signal (scanning signal) P2; and the on/off control of the first switch S1 is performed by a control signal (scanning signal) P3.

FIG. 2 is a diagram illustrating the concrete configuration of the pixel circuit of the EL display apparatus of the present exemplary embodiment. The pixel circuit of FIG. 2 includes a transistor M1, the drain of which is connected to the information line Idata; the first capacity C1 and the second capacity C2, one side terminals of which are connected to the source of the transistor M1; and a transistor M3, the drain of which is connected to the source of the transistor M1.

The pixel circuit of FIG. 2 is also includes a transistor M2, the source of which is connected to the other side terminal of the second capacity C2 and the drain of which is connected to the reference voltage source Vbias; and the transistor M5, the gate of which is connected to the other side terminal of the second capacity C2 and the drain of which is connected to the anode side of the EL element.

Furthermore, the pixel circuit includes a transistor M4, the drain of which is connected to the sources of the transistors M3 and M5. The source of the transistor M4 and the other side terminal of the capacity C1 are connected to the power supply Vcc. The cathode side of the EL element is connected to the ground potential GND.

The control signal (scanning signal) P1 is input into the gate of the transistor M1; the control signal (scanning signal) P2 is input into the gates of the transistors M2 and M3; and the control signal (scanning signal) P3 is input into the gate of the transistor M4.

The transistors M1 to M5 are P type thin film transistors (PMOS transistors).

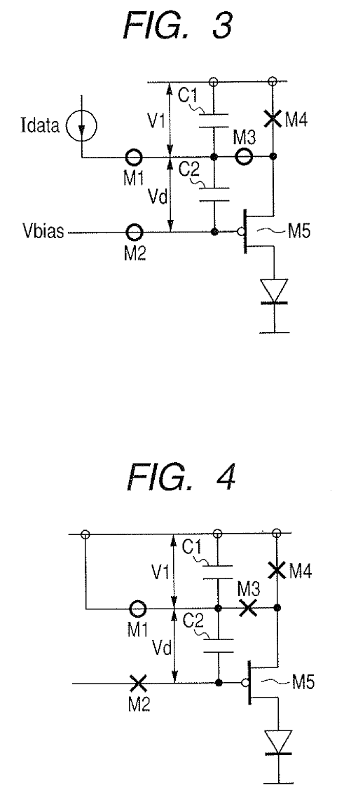

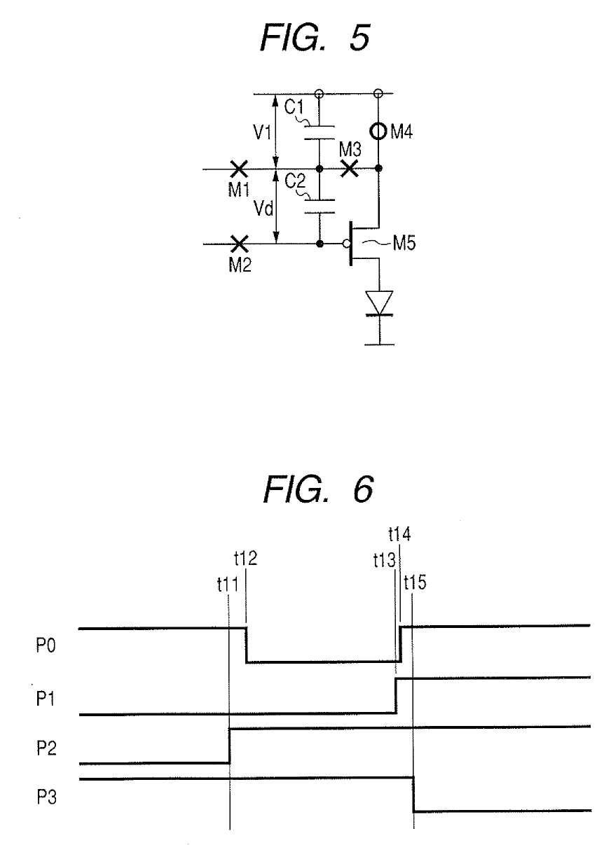

In the following, the operation of the pixel circuit will be described with reference to FIGS. 3 to 6. FIGS. 3 to 5 are diagrams for describing the operation of the pixel circuit. FIG. 6 is a timing chart illustrating the operation of the pixel circuit.

In FIGS. 3 to 5, a mark o denotes an ON state transistor, and a mark denotes an OFF state transistor.

The circuit that generates the control signals (scanning signals) P0 to P4 of FIG. 6 will be described later.

In FIG. 6, a period until a time t11 is a writing period of a data current (first operation period); a period of from a time t12 to a time t13 is a producing period of a virtual power supply (second operation period); a period on and after a time t15 is a lighting or light-out period (third operation period).

In the period until the time t11 of FIG. 6, a LOW level signal is input into the gate of the transistor M1 as the scanning signal P1, and another LOW level signal is input into the gates of the transistors M2 and M3 as the scanning signal P2. Moreover, a HIGH level signal is input into the gate of the transistor M4 as the scanning signal P3.

Then, as illustrated in FIG. 3, the transistors M1, M2, and M3 are in their ON states, and the transistor M4 is in the OFF state thereof. At this time, the gate of the transistor M5 is set to the reference potential Vbias, and the gate-to-source voltage of the transistor M5 becomes a voltage according to the current drive ability of the transistor M5 by the data current Idata. The charges according to the voltage are stored in the capacity C2.

Next, at the time t11, the scanning signal P2 is changed to the HIGH level, and the transistors M2 and M3 are thereby turned to be their OFF state. Because the transistor M2 is OFF, the charges stored in the capacity C2 are held, and the voltage thereof is also held.

In the period of from the times t12 to t13, the scanning signal P0, which will be described later, is changed to set the information line Idata to the voltage of the power supply Vcc, and the potential of the information line Idata is made to be constant potential. The potential at the connection point of the capacities C1 and C2, that is, the source potential of the transistor M5, changes from a voltage Vs to the voltage of the power supply Vcc, and the gate potential of the transistor M5 becomes Vbia+(Vcc−Vs).

Next, at the time t13, the scanning signal P1 is changed to the HIGH level, and the transistor M1 is thereby turned to the OFF state thereof. Although the data current Idata is consequently intercepted, the voltage stored in the capacity C2 is held because the transistor M2 is OFF.

Next, at the time t15, the scanning signal P3 is changed to the LOW level, and the transistor M4 is thereby turned to the ON state thereof. A current according to the current drive ability of the transistor M5 is supplied to the EL element by the voltage according to the gate-to-source voltage of the transistor M5, and the EL element emits light at the luminance according to the supplied current. The light emission period can be adjusted based on the period in which the scanning signal P3 is the LOW level, and the lighting can be put out by changing the scanning signal P3 to the HIGH level to turn the transistor M4 to be in the OFF state thereof.

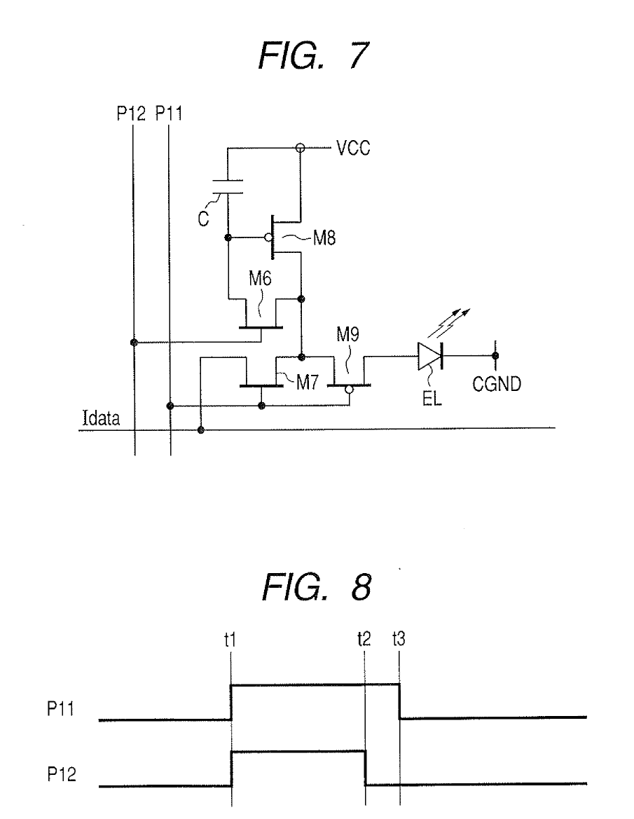

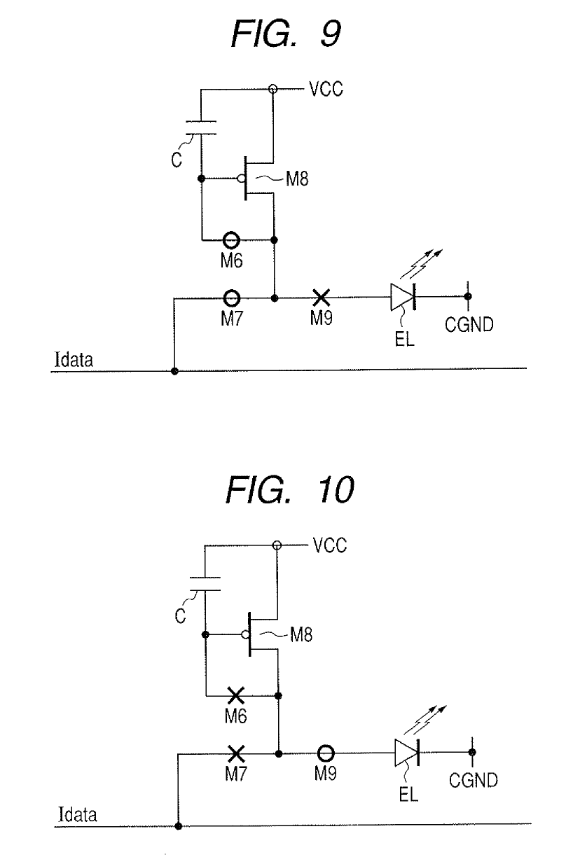

The drive transistor M5 operates in the saturated (pentode) region at both the times of the first (current writing) operation and the third (display) operation of the present exemplary embodiment. In the configuration of the conventional pixel circuit illustrated in FIG. 7, because the time of large current writing must be especially noticed, it is required to secure the power supply voltage thereof at the sacrifice of the power consumption thereof. However, because the pixel circuit of the present exemplary embodiment enables the drain-to-source voltage of the drive transistor M5 to be almost the same at both the times of large current writing and of a display operation by setting the reference potential Vbias, the voltage of the power supply Vcc can be decreased, and the power consumption thereof can be decreased.

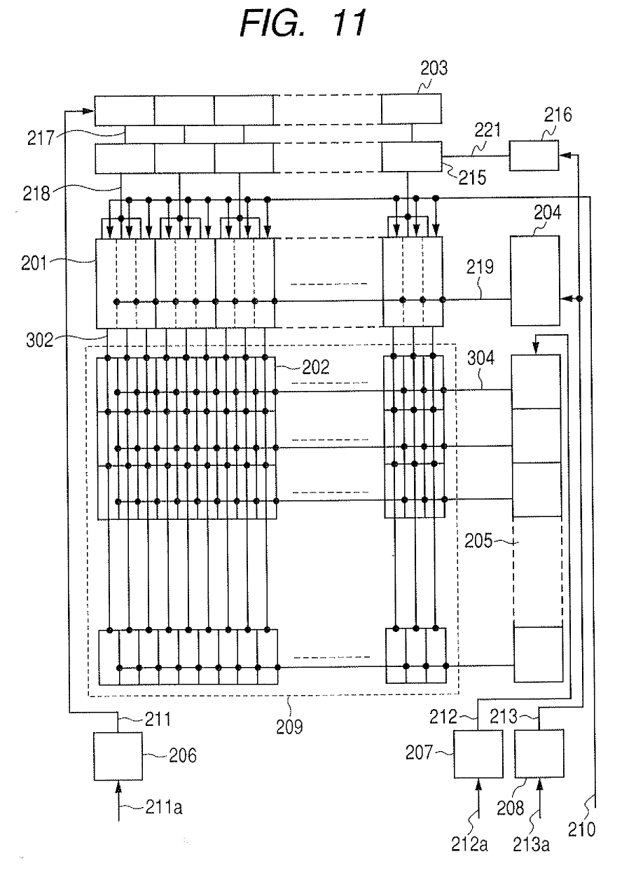

FIG. 11 is a block diagram illustrating the circuit configuration of an EL display apparatus including light-emitting elements and pixel circuits, both of which are arranged in a two-dimensional matrix.

In the EL display apparatus of FIG. 11, an input video signal of red (R), green (G) and blue (B) (hereinafter referred to as an input video signal) 210 is input into column control circuits 201, the number of which is three times as large as the number of the horizontal pixels of the EL display panel. After that, a horizontal control signal 211a is input into an input circuit 206, and the input circuit 206 outputs a horizontal control signal 211 to input the horizontal control signal 211 into a horizontal shift register 203.

An auxiliary column control signal 213a is output as an auxiliary column control signal 213 through an input circuit 208 to be input into gate circuits 204 and 216.

A group of horizontal sampling signals 217 output to the output terminals corresponding to columns of the horizontal shift register 203 are input into gate circuits 215, to which control signals 221 output from the gate circuit 216 are input. A group of horizontal sampling signals 218 converted by the gate circuits 215 are input into the column control circuits 201.

The column control circuits 201 receive control signal 219 output from the gate circuit 204.

A vertical control signal 212a is input into an input circuit 207 to be output therefrom as a vertical control signal 212, which is input into a vertical shift register 205, which is a signal generation unit. Then, scanning signals are input into row control lines 304 (three scanning lines through which the scanning signals P1, P2, and P3 are input). A data signal (data current Idata) from each of the column control circuits 201 is input into each of the pixel circuits through each of data lines 302.

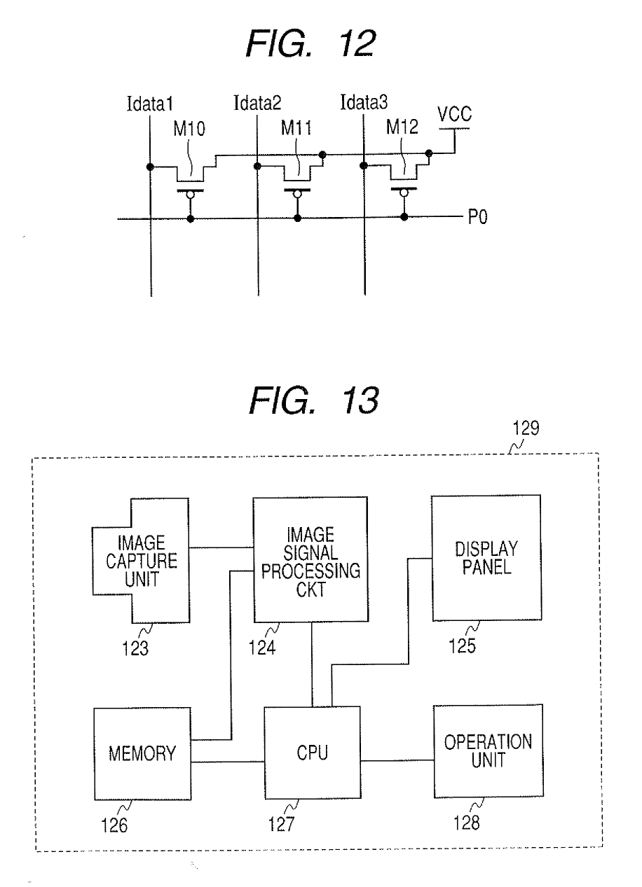

The switching of data currents Idata in information lines and the voltage of the power supply Vcc is performed by switching data currents Idata1 to Idata3 in the information lines and the voltage of the power supply Vcc by using transistors M10 to M12 and the scanning signal P0 as illustrated in FIG. 12. Incidentally, only the three information lines are illustrated in FIG. 12 for simplification. The switching units illustrated in FIG. 12 are also a part of the signal generation unit. Incidentally, in the pixel circuit of FIG. 2, the conductivity type of the transistor constituting each switch may be changed from the P type to the N type, and the pixel circuit may be provided to the cathode side of the EL element.

### Second Exemplary Embodiment

An information processing apparatus can be configured using the display apparatus of the exemplary embodiment as described above. The information processing apparatus is a portable or mobile telephone, a portable computer, a still camera, a video camera, or the like, or an apparatus realizing a plurality of the functions of the equipment as mentioned above. The information processing apparatus includes an information input unit. For example, in the case of the portable telephone, the information input unit is configured to include an antenna. In the case of a personal digital assistant (PDA) or a portable personal computer, the information input unit is configured to include an interface unit to a network. In the case of an information display apparatus such as a still camera or a movie camera, the information input unit is configured to include a sensor unit (image capture unit) such as a CCD or a CMOS.

In the following, as an exemplary embodiment of the present invention, a digital camera will be described.

FIG. 13 is a block diagram of an example of a digital still camera. The figure illustrates the whole system 129, an image capture unit 123, an image signal processing unit 124, a display panel 125, a memory 126, a CPU 127, and an operation unit 128. An image captured by the image capture unit 123 or an image recorded in the memory 126 is subjected to signal processing in the image signal processing circuit 124, and can be seen on the display panel 125. The CPU 127 controls the image capture unit 123, the memory 126, the image signal processing unit 124, and the like to perform photographing, recording, reproducing, and displaying that are suitable for the situation when a signal is input from the operation unit 128.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-181669, filed Jun. 30, 2006, which is hereby incorporated by reference herein in its entirety.

What is claimed is:

1. A display apparatus comprising light-emitting elements arranged in an array and pixel circuits for supplying currents to the light-emitting elements individually,
each of the pixel circuits including:
a drive transistor having a main electrode connected to a first power supply via the corresponding light-emitting element, another main electrode connected to a second power supply via a first switch and connected to an information line, to which a data current is supplied, via a series connection of a second and a third switches and a control electrode connected to a third power supply via a fourth switch;
a first capacity having a terminal connected between the second and the third switches and another terminal connected to the second power supply;
a second capacity having a terminal connected between the second and the third switches and another terminal connected to the control electrode of the drive transistor; and
a unit which generates control signals for performing:
a first operation of connecting the control electrode of the drive transistor to the third power supply by turning on the fourth switch and inputting the data current into the other main electrode of the drive transistor by turning off the first switch and turning on the second and the third switches;
a second operation following the first operation of connecting the information line to the second power supply while turning off the third and the fourth switches; and
a third operation following the second operation of supplying the current to the light-emitting elements by turning on the first switch and turning off the second switch.

2. A drive method of a display apparatus comprising light-emitting elements arranged in an array and pixel circuits for supplying currents to the light-emitting elements individually,
each of the pixel circuit including:
a drive transistor having a main electrode connected to a first power supply via the corresponding light-emitting element, another main electrode connected to a second power supply via a first switch and connected to an information line, to which a data current is supplied, via a series connection of a second and a third switches, and a control electrode connected to a third power supply via a fourth switch;
a first capacity having a terminal connected between the second and the third switches, and another terminal connected to the second power supply; and
a second capacity having a terminal connected between the second and the third switches, and another terminal connected to the control electrode of the drive transistor,
the method comprising the steps of:
connecting the control electrode of the drive transistor to the third power supply by turning on the fourth switch and inputting the data current into the other main electrode of the drive transistor by turning on the second and the third switches and turning off the first switch;
connecting the information line to the second power supply while turning off the third and the fourth switches; and
supplying the current to the light-emitting elements by turning on the first switch and turning off the second switch.

3. An information processing apparatus comprising:
the display apparatus according to claim 1;
an image capture unit for capturing an image of a subject; and
an image signal processing circuit processing a signal of the image captured by the image capture unit,
wherein an image signal subjected to signal processing by the image signal processing circuit is displayed on the display apparatus.
